(19) United States
(12) Patent Application Publication
(10) Pub. No.: US 2013/0242709 A1
(43) Pub. Date: Sep. 19, 2013

(54) HAND-WORN DEVICE WITH PROGRAMMABLE MEMORY

(71) Applicant: IDT TECHNOLOGY LIMITED, Hong Kong SAR (CN)

(72) Inventor: Raymond CHAN, Hong Kong (CN)

(73) Assignee: IDT TECHNOLOGY LIMITED, Hong Kong SAR (CN)

(21) Appl. No.: 13/787,827

(22) Filed: Mar. 7, 2013

Related U.S. Application Data
(60) Provisional application No. 61/612,386, filed on Mar. 18, 2012.

(51) Int. Cl. G04G 99/00

(52) U.S. Cl. CPC G04G 99/006
USPC 368/10; 368/223

(57) ABSTRACT

A hand-worn device with programmable memory is disclosed. In one embodiment, the apparatus comprising a display unit, an attachment strap attached to the display unit where the attachment strap is adapted to attach the apparatus to a user, and a processing unit electrically coupled to the display unit. The apparatus further comprises a programmable memory, the programmable memory having at least one operation algorithm installable therein. The processing unit runs one of the operation algorithms to operate the apparatus at a corresponding operation mode, where at least one parameter is displayed on the display unit. The device allows a user to choose the desired operation algorithms to be installed to the device for optimized usage of memory space.

### CROSS-REFERENCE TO RELATED APPLICATION

This application claims benefit under 35 U.S.C. §119(e) of U.S. Provisional Application having Ser. No. 61612386 filed on Mar. 18, 2012, which is hereby incorporated by reference herein in its entirety.

### FIELD OF INVENTION

This invention relates to a hand-worn device such as a watch, and in particular a hand-worn device with programmable memory.

### BACKGROUND OF INVENTION

Traditional hand-worn devices such as watches allow a user to know the present time. Nowadays, more and more functions are incorporated into the watch, however it is difficult to find a watch that all functions are desired by the user. Also, more functions generally means a larger volume, higher cost and more power consumption.

### SUMMARY OF INVENTION

In the light of the foregoing background, it is an object of the present invention to provide an alternate hand-worn device that solves at least one of the aforementioned problems.

Accordingly, the present invention, in one aspect, is an apparatus comprising a display unit, an attachment strap attached to the display unit where the attachment strap is adapted to attach the apparatus to a user, and a processing unit electrically coupled to the display unit. The apparatus further comprises a programmable memory, the programmable memory having at least one operation algorithm installable therein. The processing unit runs one of the operation algorithms to operate the apparatus at a corresponding operation mode, where at least one parameter is displayed on the display unit.

In an exemplary embodiment of the present invention, the apparatus further comprises a communication unit electrically coupled to the processing unit. The communication unit is adapted to receive the operation algorithm from a remote device and install in the programmable memory.

In a further embodiment, the communication unit is adapted to transmit the displayed parameter to the remote device. In another embodiment, the communication unit is adapted to communicate with at least one sensor in a sensing device for obtaining the parameter for display.

In yet another embodiment, the sensing device comprises a chest belt and the sensor comprises a heart rate sensor

In an exemplary embodiment of the present invention, the operation algorithm is removable from the programmable memory.

In another embodiment, the apparatus further comprises at least one sensor for detecting the parameters for display. The sensor comprises an accelerometer.

There are many advantages to the present invention. A first advantage is that the programmable memory allows the user to install only the desired operation algorithms, while avoiding installing any undesired operation algorithms. As a result, the limited resource of memory space is most efficiently utilized for optimized performance of the device. By communicating to an external sensor, the range of parameters detected and displayed can be expanded.

A second advantage is that the user can download from a host device and install a new operation algorithm onto the apparatus, so that the apparatus can be re-configured to perform a new function when such new operation algorithm is invoked. In one embodiment, the apparatus can perform not only as a real-time clock but also as a weather forecasting station, an exercise monitoring device, a calorie coach and also a heart-rate monitor.

Another advantage of the present invention is that the choice and settings of the display unit is optimized for minimum power consumption, allowing the majority of the power to be used in communication and/or detection of parameters.

### BRIEF DESCRIPTION OF FIGURES

FIG. 1 is a front view of the hand-worn device according to an embodiment of the present invention.

FIG. 2 is a block diagram of the electrical structure inside the device according to an embodiment of the present invention.

FIG. 3 is a flow chart of updating operation algorithms from a remote device, according to an embodiment of the present invention.

FIG. 4 is a sample display in a time mode, showing two separate times on the display unit.

FIG. 5 is a flow chart of operation of a calorie coach mode of the device, according to an embodiment of the present invention.

FIG. 6 is a flow chart of operation of a running mode of the device, according to an embodiment of the present invention.

FIG. 7 is a flow chart of operation of a workout mode of the device, according to an embodiment of the present invention.

### DETAILED DESCRIPTION OF THE PREFERRED EMBODIMENTS

As used herein and in the claims, “comprising” means including the following elements but not excluding others.

As used herein and in the claims, “couple” or “connect” refers to electrical coupling or connection either directly or indirectly via one or more electrical means unless otherwise stated.

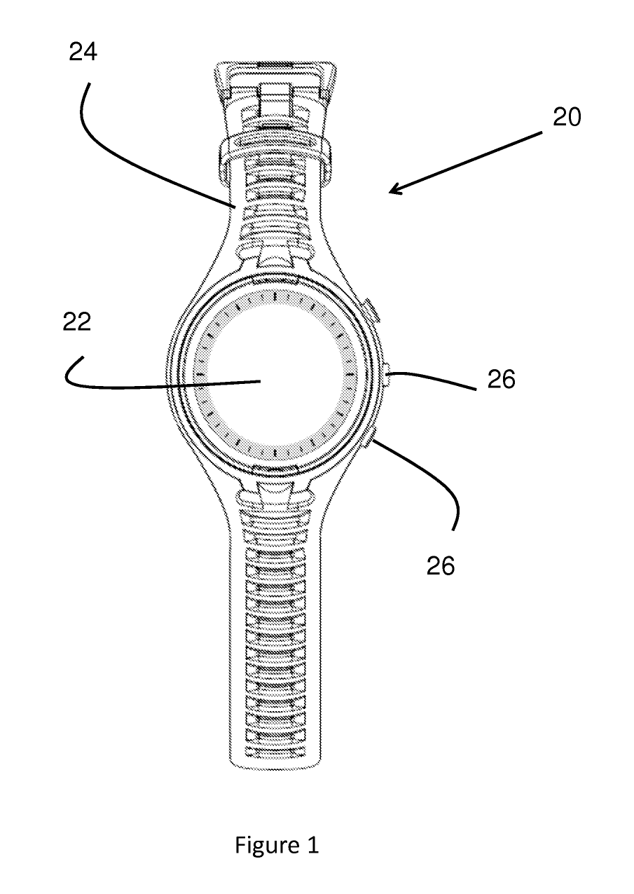

Referring now to FIG. 1, the first embodiment of the present invention is a hand-worn apparatus or device 20 such as a watch, having a display unit 22 and an attachment strap 24 for attaching the device 20 to the wrist of a user. A plurality of control buttons 26 are provided adjacent to the display unit 22 for controlling the operation of the device 20. In one embodiment, there are three control buttons on one side of the apparatus 20 for the users to select and control the apparatus 20.

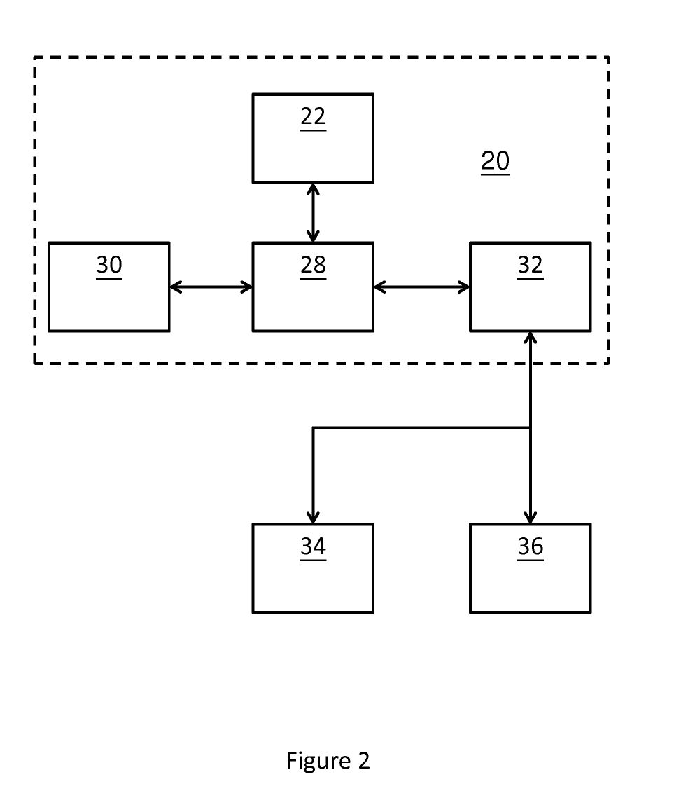

Referring now to FIG. 2, the display unit 22 is electrically coupled to a processing unit 28. The processing unit 28 is in turn coupled to a programmable memory 30 and a communication unit 32. The communication unit 32 is adapted to communicate with a remote device 34, a sensing device 36, or both. In an exemplary embodiment, the communication unit 32 is a wireless transceiver. In a further embodiment, the ANT+ (or ANT PLUS) protocol is used for data exchange between the hand worn apparatus 20 and the sensing device 36. In yet another embodiment, the apparatus 20 is adapted to communicate with devices running an Android application for software download or data upload. In other embodiments, the communication unit 32 is adapted to communicate through wired mechanisms. The programmable memory 30 can be installed with at least one operation algorithms. Each operation algorithm is runnable on its own by the processing unit 28, and each operation algorithm corresponds to a separate operation mode of the device 20. Each operation mode is explained in more detailed below. In an exemplary embodiment, the operation algorithm is downloaded from the remote device 34 to the programmable memory 30 through the communication unit 32. The remote device 34 is preferably a portable electrical device such as a smart phone, but also can be a personal computer, or simply a storage device without any processing capabilities.

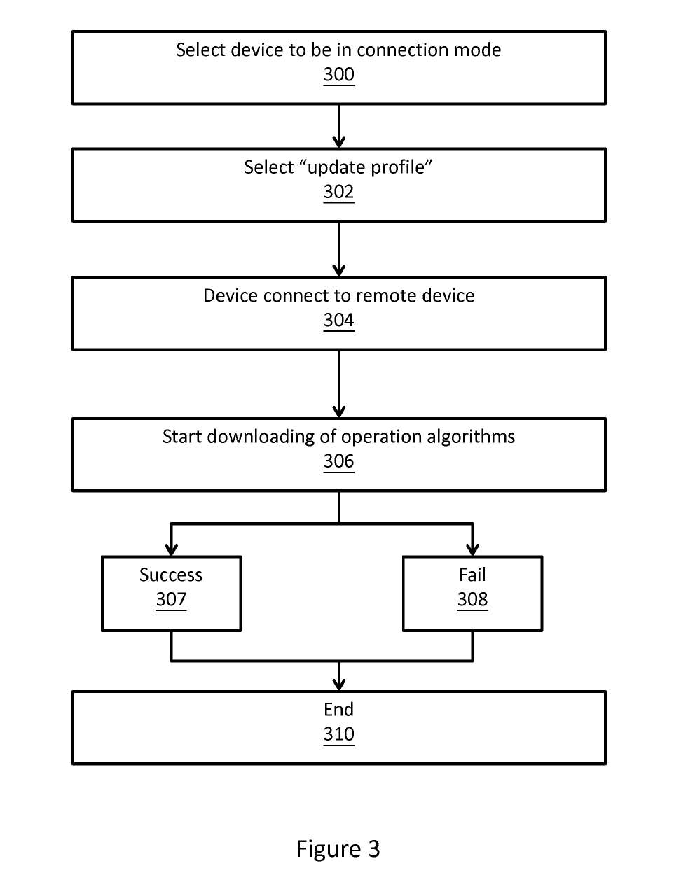

In an exemplary embodiment as shown in FIG. 3, the process of downloading operation algorithms is initiated at the device 20. First, the device 20 is selected to be in a connection mode (step 300), and then the option of “update profile” is selected (step 302). The device 20 will attempt to connect to the remote device 34 in this mode (step 304). After establishing connection, the display unit 22 will start downloading all operation algorithms stored in the remote device 34 (step 306). The result of the transfer, either success or fail, will then be displayed (step 307 or 308), and the process ends at step 310. In another embodiment, the available operation algorithms are displayed on the device 20 for the user to choose to download before the download starts.

In an exemplary embodiment, the downloaded operation algorithms can be deleted from the programmable memory 30. This feature ensures that the limited size of the programmable memory 30 will not be permanently wasted for modes that are no longer useful to the user. New operation algorithms can also be downloaded to replace the deleted operation algorithms. In an exemplary embodiment, the condition for starting the deletion process is sufficiently complex in order to prevent accidental deletion. In a specific embodiment, a first combination of control buttons 26 are simultaneously pressed for a first predetermined period of time, then a second combination of control buttons 26 are then subsequently simultaneously pressed for a second predetermined period of time to trigger a deletion process. It is obvious that the number of such combinations are arbitrary and is preferably to be three or above.

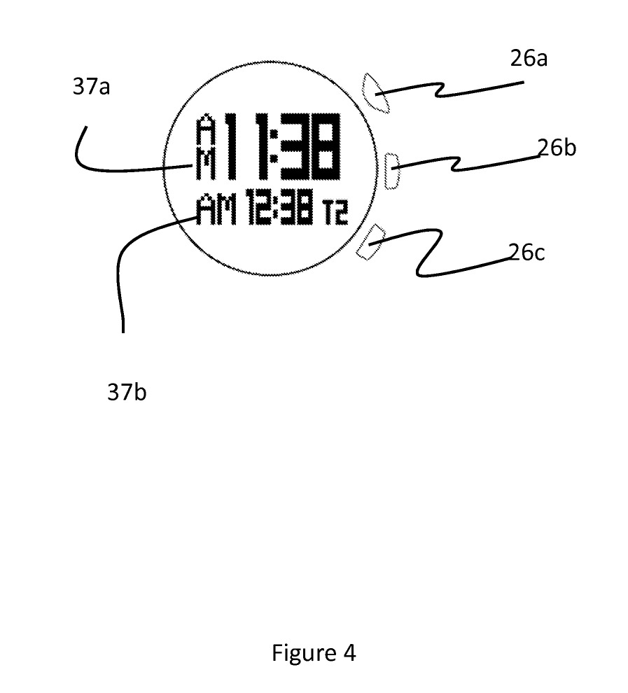

In one embodiment, there are three control buttons on one side of the apparatus 20 for the users to select and control the apparatus 20. They are labeled as K1 (26a), K2 (26b) and K3 (26c) in FIGS. 4 to 7 respectively. These control buttons serves as navigation keys for the users to select the particular operation algorithm to invoke, to navigate along the sub-menus provided by that operation algorithm, and also as input keys for the users to enter a value or a parameter required by the operation algorithm.

In an exemplary embodiment, a first operation mode is a time mode. As shown in FIG. 4, the time mode can display at least one time data on the display unit 22, such as a first time 37a and a second time 37b. The time mode functions like a general clock, and alarm functions can be set by the user. In one embodiment, this mode is permanently installed in the device 20 separate from the programmable memory 30.

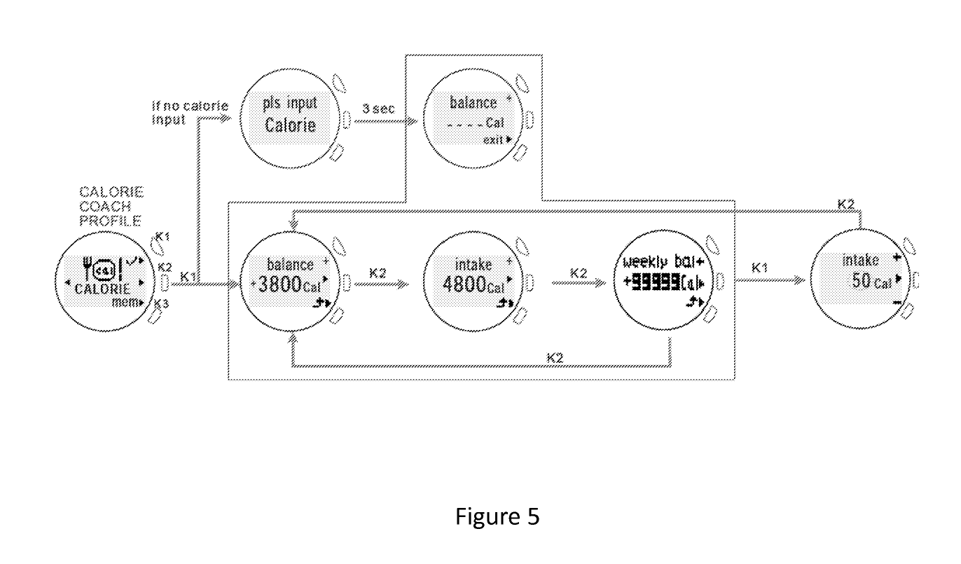

In an exemplary embodiment, a second operation mode is a calorie coach mode. FIG. 5 shows the state flow diagram of the apparatus in this mode. In general, the apparatus displays a message on the display unit 22 and wait for user input. The message may contain a text or a text plus a parameter value. The user can then make use of the control buttons K1 (26a), K2 (26b) and K3 (26c) to input a value or to navigate to another state. As shown in FIG. 5, the calorie coach mode allows the user to enter the intended calorie balance and the amount of calorie intake. The calorie balance equals to the subtraction between the calorie intake and the calorie consumption. After the input, the display unit 22 then shows the amount of allowable calorie intake in order to achieve the intended calorie balance. In the absence of calorie input, the system will prompt the user to enter a value by popping up a message of “pls input calorie” for a predetermined duration, say 3 second. If a value is not entered within the predetermined time, the system will use the default value for calculation. The calorie coach mode can also calculate the calorie consumption based on the types of exercise of the user such as running, swimming and cycling, etc.

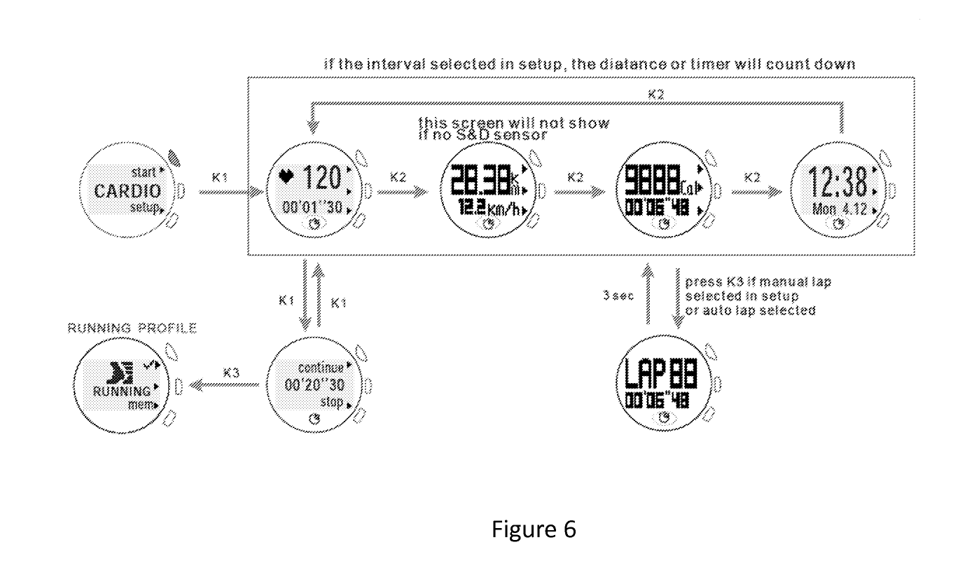

In an exemplary embodiment, a third operation mode is a running mode. The operational state diagram is shown in FIG. 6. In the running mode, the apparatus receives heartbeat rate information from a chest belt separate from the watch and displays on the display unit 22. In one embodiment, the running mode also shows a time period of the run, the running speed through an internal or external accelerometer or termed Speed and Distance (S&D) sensor, an amount of calorie burned and/or lap information. Similar to the other modes, the user can use of the control buttons K1 (26a), K2 (26b) and K3 (26c) to navigate and each of these parameters can be displayed together or in predetermined combinations, depending on the size of the display unit 22.

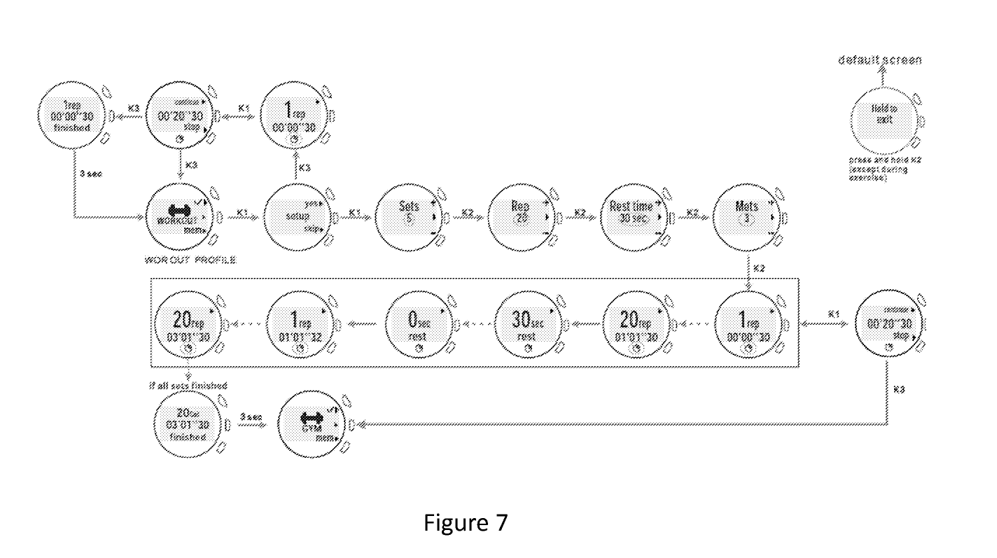

In an exemplary embodiment, a fourth operation mode is a workout mode. The operational state diagram of this mode is shown in FIG. 7. The workout mode has counters to count repetitions and number of sets. The period of rest time between sets, or other times such as time elapsed within a repetition can also be counted and displayed. Similarly, an amount of calorie burned can also be detected and displayed.

In an embodiment, a fifth operation mode is a hiking mode. The hiking mode displays a direction of the watch from an internal or external compass, for example in the form of cardinal points. The latitude and longitude of the watch are also displayed for example from a link to a device with global positioning system. A barometric pressure sensor can also be installed in the device and the pressure can be displayed.

In an embodiment, a sixth operation mode is a fishing mode. The fishing mode displays a fish amount prediction based on predetermined parameters, and also moon phase data which affects fish behavior. The moon phase data information is not affected by weather, and thus is more reliable than the naked eye.

In an embodiment, a seventh operation mode is a weather forecast mode. The weather forecast mode displays a current weather such as sunny, cloudy or raining etc., and can also display a forecast for a predetermined period of time. Internal or external thermometers and/or humidity sensors can also allow temperature and humidity information to be displayed on the display unit 22. Any weather alerts, such as typhoon warnings, snow alert, or any other alerts issued by the government can also be displayed by connecting the device 20 to the appropriate sources, or to the remote device 34.

In an exemplary embodiment, data or parameters displayed on the display unit 22 in any of the operation modes can be recorded and uploaded back to the remote device 34. In one embodiment, the recorded data type is fixed for each operation mode, while in other embodiments the recorded data type can be customized. The data is stored in the programmable memory 30 for a predetermined period of time in order to limit memory usage, and will be permanently deleted if the data is not uploaded to the remote device 34 within the period of time. Once the upload is completed, the uploaded data will also be deleted from the device 20.

In an exemplary embodiment, the display unit 22 of the device 20 is made of a black-and-white LCD display with backlight. This option ensures minimum power consumption for displaying the necessary parameters such that the majority of the power can be used for communicating with other devices and/or detecting the parameters.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, the operation modes listed above are only described by way of example but not limitation. It is obvious to one skilled in the art that any combination of parameters displayed and detected, either through internal or external sensors, are possible without departing from the spirit of the invention. In one embodiment, the user can customize the combination of parameters displayed through a program for example in the remote device 34.

What is claimed is:

1. An apparatus comprising:
a) an attachment strap for attaching said apparatus to a user;
b) an electronic module housed in said apparatus; said electronic module further comprises a processing unit, a display unit and a programmable memory interconnected with one another
wherein said programmable memory having at least one operation algorithm installable therein;
wherein said processing unit runs one of said operation algorithm to operate said apparatus at a corresponding operation mode, whereby at least one parameter is displayed on said display unit.

2. The apparatus according to claim 1, wherein said apparatus further comprises a communication unit electrically coupled to said processing unit, said communication unit adapted to receive said at least one operation algorithm from a remote device.

3. The apparatus according to claim 2, wherein said communication unit is a wireless transceiver adapted to wirelessly communicate with a remote device.

4. The apparatus according to claim 2, wherein said remote device runs the Android system.

5. The apparatus according to claim 2, wherein said communication unit is adapted to communicate with at least one sensor in a sensing device.

6. The apparatus according to claim 5, wherein said sensing device comprises a chest belt, said at least one sensor comprises a heart rate sensor.

7. The apparatus according to claim 5, wherein said apparatus communicates with said sensing device using ANT+ protocol.

8. The apparatus according to claim 1, further comprising at least one sensor for detecting said at least one parameter for display.

9. The apparatus according to claim 8, wherein said at least one sensor comprises an accelerometer.

10. The apparatus according to claim 1, wherein said at least one operation algorithm is removable from said programmable memory.

11. The apparatus according to claim 1, wherein said operation mode comprises a time mode, a calorie coach mode, a running mode, a workout mode, a hiking mode, a fishing mode and a weather forecast mode.

12. The apparatus according to claim 1 further comprising one of the following sensors for measuring said at least one parameter:
a) a heart rate sensor;
b) an accelerometer;
c) a Speed and Distance (S&D) sensor;
d) a barometric pressure sensor;
e) an internal or external thermometers;
f) a humidity sensor; or
g) a combination thereof.
